(19) United States
(12) Patent Application Publication
(10) Pub. No.: US 2026/0182505 A1
(43) Pub. Date: Jul. 2, 2026

(54) MUSHROOM GROWING SHELVING, TROLLEY AND CORRESPONDING ASSEMBLY

(71) Applicant: Jacobus Alexander Jozef LEMMEN, Venlo (NL)

(72) Inventor: Jacobus Alexander Jozef LEMMEN, Venlo (NL)

(21) Appl. No.: 19/121,301

(22) PCT Filed: Oct. 11, 2023
(86) PCT No.: PCT/EP2023/078175

§ 371 Date: Apr. 15, 2025

(30) Foreign Application Priority Data
Oct. 21, 2022 (NL) 2033375
Feb. 14, 2023 (NL) 2034143

(51) Int. Cl. A01G 18/62; A01G 18/70

(52) U.S. Cl. CPC A01G 18/62; A01G 18/70

(57) ABSTRACT

The invention concerns a mushroom growing shelving (101), comprising a plurality of beds (102, 103, 104, 105, 106) placed one above the other for keeping compost and/or casing soil, a frame (107) coupled or connectable to the shelving, which can be moved along the shelving with at least a horizontal directional component and a harvest belt conveyor which comprises a harvest belt extending al least partially parallel to the beds, supported by a number of guides (109, 110,111, 112) over which the harvesting belt can move, whereby at least one of the guides (109, 110,111, 112) is connected to the frame (107) and can be moved along it with at least a vertical directional component, for guiding the harvesting belt at least locally at an adjustable height along the shelving. The invention also concerns a trolley (1) for moving picking personnel (2, 3) for the manual harvesting of mushrooms along a mushroom growing shelving (101).

The present invention relates to a trolley for moving picking personnel along a shelving for growing those mushrooms for the purpose of manually harvesting mushrooms.

Mushrooms are harvested in cultivation beds located in shelvings. Such shelving can extend over a length of several to several tens of meters, whereby several beds can extend above each other in the shelving.

In order to make it easy for the picking staff to move along the beds during picking, it is common to use so-called picking lorries. These picking lorries include a cart that is designed to move along the shelving. The picking lorries according to the state of the art are often connected to the shelving via a rail system or similar guide.

It is further known to design the lorries for picking mushrooms on beds that are placed one above the other in the shelving in such a way that the picking personnel can be moved in height.

A particularly suitable embodiment according to the state of the art is described in the Dutch patent NL 2022318. This picking lorry has a provision for guiding a harvesting belt through the lorry, which harvesting belt also moves in height when the picking personnel is lifted by the lorry.

Although this lorry performs very well in practice, there is room for further improvement. In situations where the lorry is used in combination with a tilting shelving for growing mushrooms, as known from the Dutch patents NL 2021053 and NL 2021456, but especially when the lorry is used with an old-fashioned type of shelving, where the beds are in have a fixed orientation relative to the shelving, it can be difficult for the picking staff to pick mushrooms that are far from the edge of the shelving.

It is therefore a first aim of the present invention to propose a lorry that eliminates this above-mentioned disadvantage of the prior art. It is a further object of the present invention to provide a useful alternative to the known picking lorries.

To this end, the invention proposes a lorry for moving picking personnel for the manual harvesting of mushrooms along a shelving for growing those mushrooms, which lorry has two longitudinal sides extending between a front and a rear of the lorry, one of which the longitudinal side is designed to be moved parallel to the longitudinal direction of the shelving during intended use, the lorry comprising an accommodation in or on which personnel can sit, such as a standing surface or a sitting surface, kept at a distance relative to a surface, such as a floor surface on which the lorry is movable and a guide for guiding a harvesting belt extending flatly along the shelving in a path through the lorry, wherein the path comprises a first portion in the longitudinal direction, wherein the harvesting belt is located on one longitudinal side of the lorry at a working height defined in relation to the standing surface or the sitting surface for the staff to place harvested mushrooms on the belt, and a second part in which the harvest belt is located at an angle relative to the standing surface or the sitting surface, the height is lower than the working height to provide at least substantially unobstructed access to the shelving for harvesting mushrooms during use.

The lorry according to the present invention makes it possible for picking personnel to place mushrooms at a working height on a picking belt on a first part of the lorry, and to approach the shelving up close on a second part of the lorry to be further from the side of the lorry. position to reach growing mushrooms. You can optionally stand in one of the two positions, or work with several picking personnel on the same lorry, whereby the lorry according to the invention makes it possible for different persons to harvest a different strip of the bed. A person standing at the part where the belt is at working height can harvest a part of the bed adjacent to the outside of the shelving, while a person standing at the part of the shelving where the belt is under the working height, can harvest mushrooms from a part further from the outside of the shelving. The part of the lorry where the belt is not at working height provides essentially unobstructed access to the shelving. The invention also offers picking personnel the opportunity to work in a position or posture that is comfortable for them.

In one embodiment, the working height is between 60 and 150 cm and in particular between 90 and 120 cm above a standing surface, or between 0 and 60, and in particular between 20 and 40 cm above a seat.—right. These heights have proven to be comfortable for harvest personnel.

In a further preferred embodiment, the track is located on at least part of the front side of the longitudinal side at a lower height than the working height and on at least part of the rear side of the longitudinal side on the working height. working height. In the part where the belt is lower than the working height, it can be located, for example, at the height of the standing surface, or even lower, so that a shelving is fully accessible from the lorry.

In yet a further embodiment, the guide guides the belt along a track that is substantially S-shaped in side view, wherein the track comprises an input location at a front on a low side of the S, and at the rear on the high side of the S includes an output location. The high side can correspond at least substantially to the working height. Because the belt on the output side will be filled with mushrooms during use, it cannot be guided downwards steeply on the output side. The further guidance of the belt with mushrooms will therefore take place under a sloping slope or at the discharge height.

For the removal of harvested mushrooms under a sloping slope, the lorry according to the present invention can be used in combination with a so-called perforated conveyor, in particular with a perforated conveyor as described in the Dutch patent NL 2023167.

In yet a further embodiment, the input location is at a height between 0 and 50 cm from the surface. This makes it possible to easily step over the harvest belt outside the lorry.

To adjust the working height with a mushroom growing bed in the shelving, the sitting surface and/or the standing surface and the first part of the track can be movable in height relative to the surface. The output location can be moved in height along with the sitting surface and/or the standing surface.

In a trolley according to the present invention, the track is defined in a first embodiment by a number of roller guides connected to the lorry, through which the belt can be looped during use. In order to be able to move the lorry between different shelvings, or to maintain them, it is advantageous if it can be moved autonomously. As is further explained in this application, this can be achieved in that the roller guides connected to the lorry are releasably connected to the lorry. Furthermore, it is advantageous if the guide for the belt is freely accessible on a longitudinal side facing the shelving during use, for placing the belt on the guide or removing the belt from the guide.

The invention further relates to an assembly of a shelving for growing mushrooms, in which there are one or more growing beds for growing mushrooms, with a harvest belt extending lengthwise along the shelving; and a lorry of the type described above.

The picking lorries according to the state of the art often include a cart, which is designed to move along the shelving. These picking lorries are often connected to the shelving via a rail system or similar guide.

Although the lorries according to the state of the art and in particular the lorry from NL 2022318 perform very well in practice, there has been room for further improvement. The Dutch patent NL 2033375 provides additional features that are advantageous in situations where the lorry is used in combination with a tilting shelving for growing mushrooms, as known from the Dutch patents NL 2021053 and NL 2021456, but in particular when the lorry is used with an old-fashioned type of shelving, where the beds are in a fixed orientation relative to the shelving. Patent applications NL 2021053, NL 2021456, NL 2022318 and NL 2033375 are included in this application by reference. This means that all properties of shelvings and lorries described in these publications may apply individually or in combinations, whether or not described, to the shelvings, lorries and trolleys according to the present invention.

Both the lorry described in NL 2022318 and that described in NL 2033375 appear to function excellently in practice. Due to this proven suitability, it is desirable to carry out as much harvesting work as possible with this type of lorry. As NL 2033375 already mentioned, the lorries can be moved autonomously between different shelvings. This means that they are not permanently connected to a shelving and are not necessarily attached to a rail connected to the shelving. Such autonomously movable lorries are also referred to in the field as a trolley. In order to distinguish between a trolley that can be moved via a rail and an autonomously moveable trolley, the latter type will be referred to as a trolley in the remainder of this application.

Trolleys have the advantage over lorries that they are easier to move between shelvings, because they do not require a rail system to be moved. This ease of movement, in combination with the relatively high share in the costs of a mushroom growing shelving that a trolley entails, means that people regularly choose to use a trolley when harvesting mushrooms from different shelvings and move the trolley along the different shelvings.

A disadvantage of this, however, is that the harvesting belt that runs along a relevant shelving must be connected to or disconnected from the trolley each time the trolley is changed from shelving.

To overcome the above disadvantages, the invention proposes a shelving, a trolley and an assembly of both.

The trolley according to the present invention can have all the above-mentioned properties and characteristics with regard to a trolley according to the invention. In combination with providing a sitting or standing place for picking personnel or as an alternative thereto, a trolley according to the invention can also be provided with automated picking or harvesting means such as a picking robot or automated cutting means. These can also be designed to place picked or harvested mushrooms on a harvesting belt for removal, and therefore benefit from a harvesting belt that moves with the picking height.

In a trolley according to the present, the track is preferably (partly/among other things) defined by a number of roller guides connected to the trolley, through which the belt can be looped during use. In order to be able to move the trolley between different shelvings, or to maintain them, it is advantageous if it can be moved autonomously. Furthermore, it is advantageous for that purpose if the guide for the belt is freely accessible on a longitudinal side facing the shelving during use, for placing the belt on the guide or removing the belt from the guide. The trolley according to the invention is particularly designed for cooperating with a shelving according to the present invention, and in particular for moving a frame coupled to that shelving along such a shelving. In that case, such a frame can comprise all or part of the above-mentioned roller guides, which are then connected to the trolley by coupling the trolley to the frame.

The invention further relates to an assembly of a shelving for growing mushrooms, in which there are one or more growing beds for growing mushrooms, with a harvest belt extending lengthwise along the shelving; and a trolley of the kind described above.

The invention will now be further explained with reference to the following figures.

Herein:

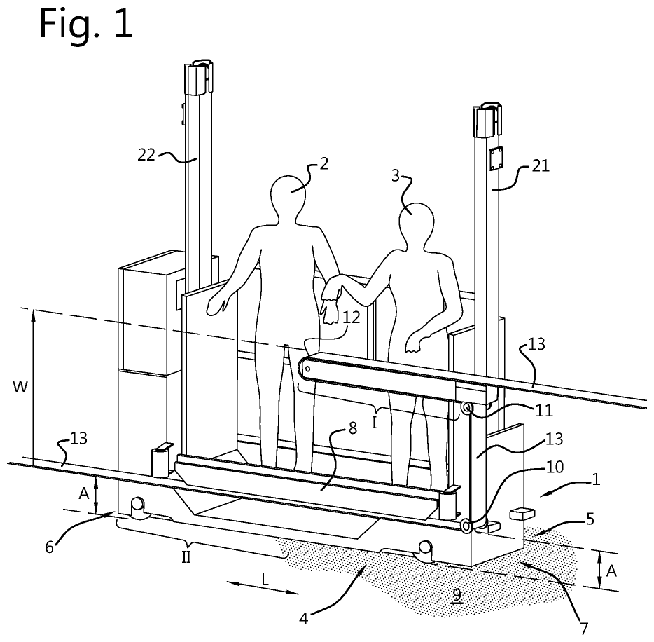

FIG. 1 shows a perspective view of a first embodiment of the present invention;

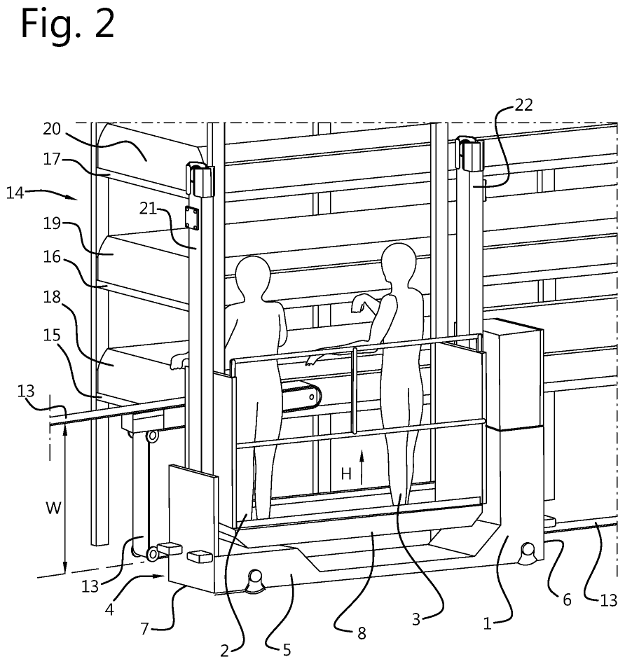

FIG. 2 shows a combination of the first embodiment and a shelving;

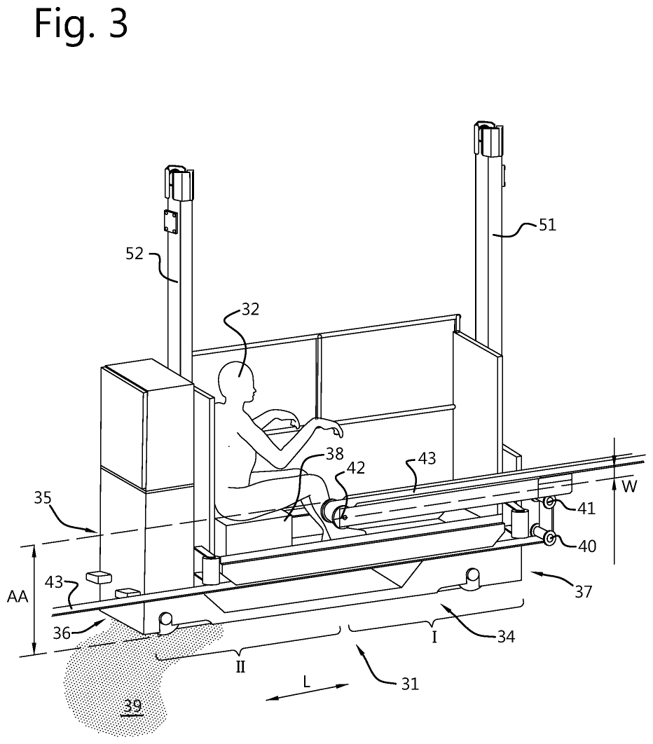

FIG. 3 is a perspective view of a second embodiment of the present invention;

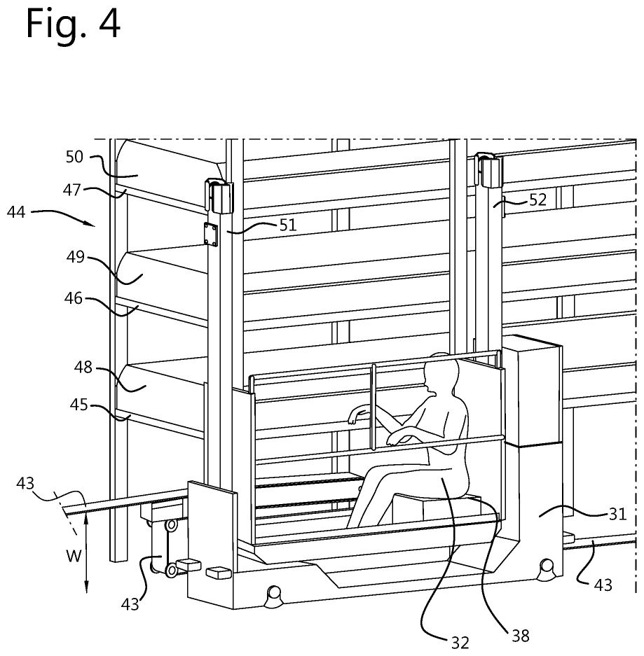

FIG. 4 is a combination of the second embodiment and a shelving.

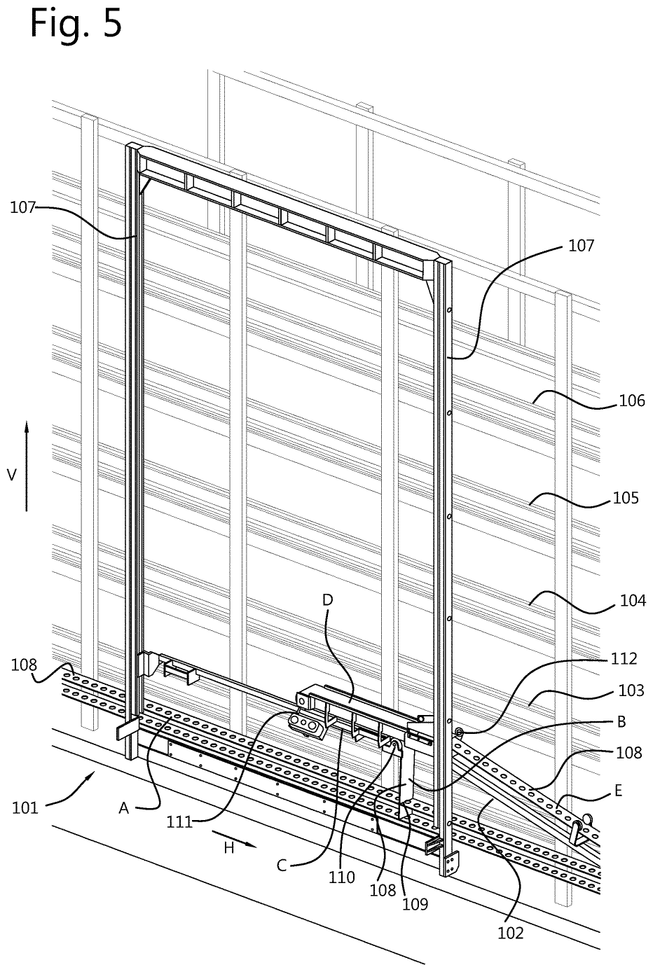

FIG. 5 shows a perspective view of a shelving according to the present invention;

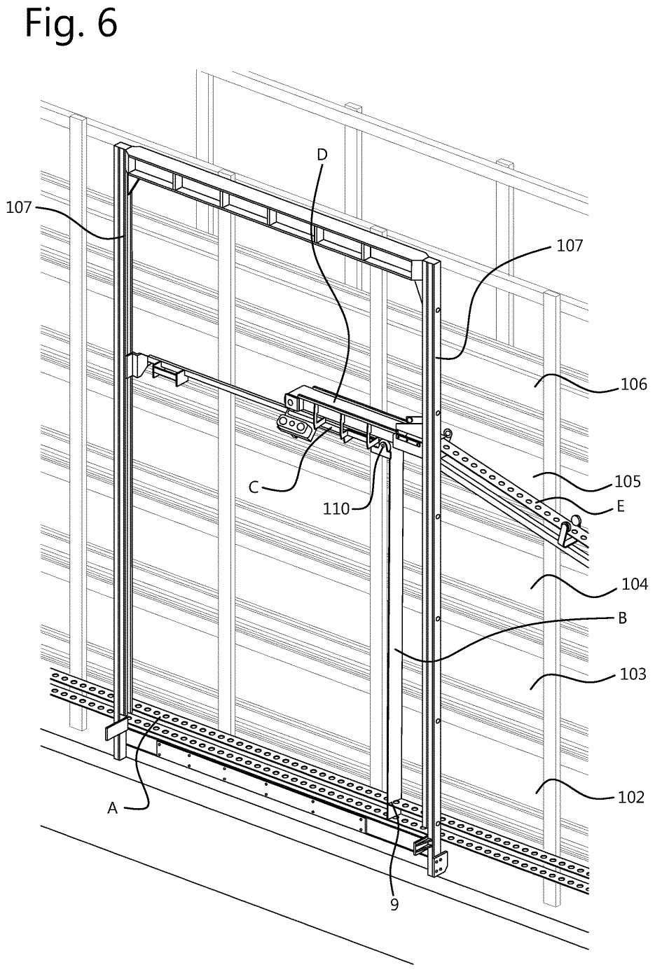

FIG. 6 shows a second view of the shelving from FIG. 1;

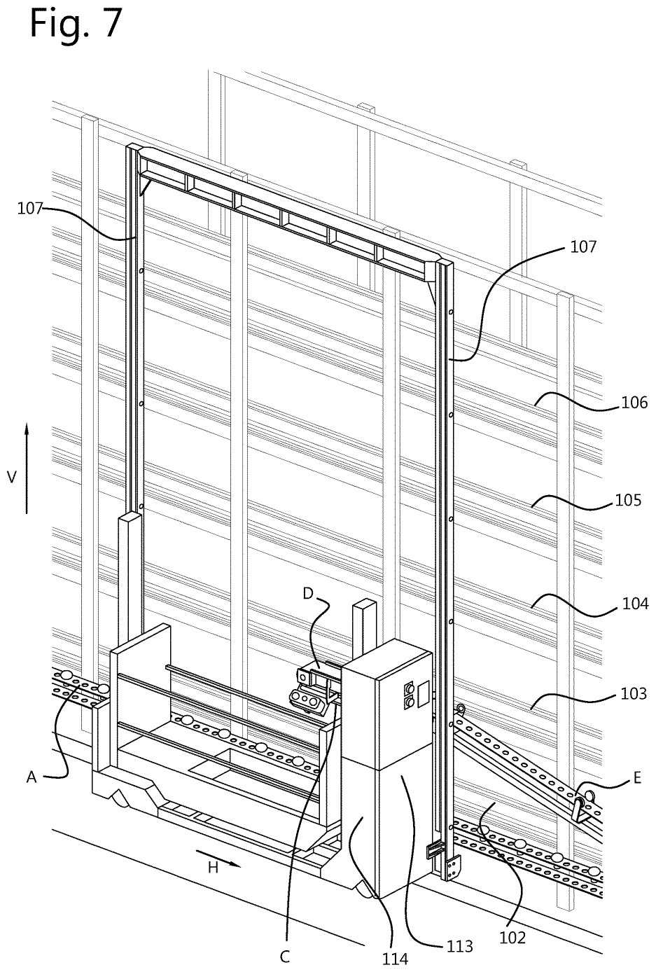

FIG. 7 assembly according to the present invention; and

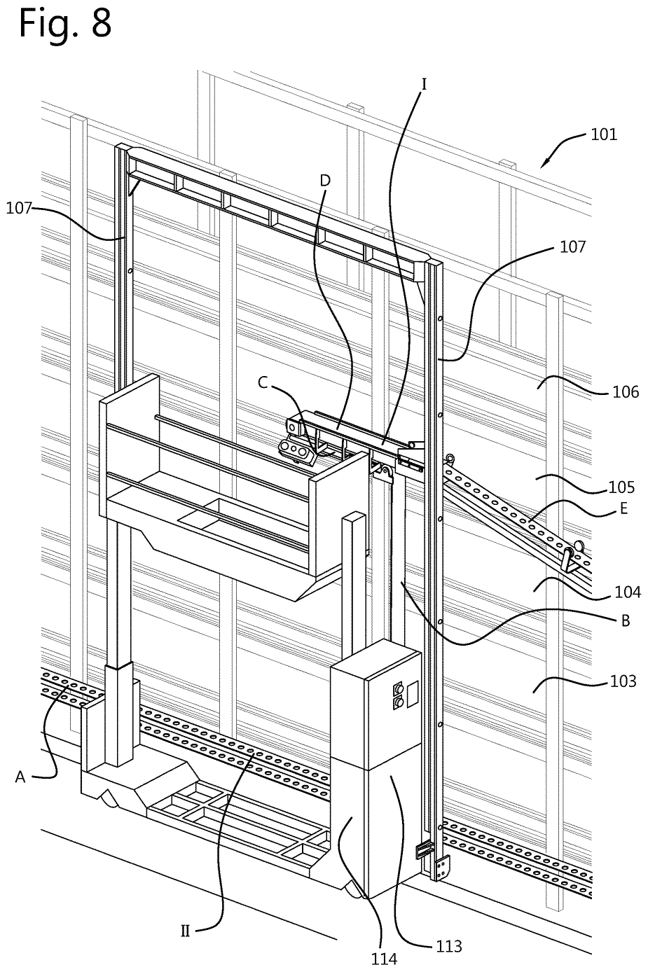

FIG. 8 is a second view of the assembly from FIG. 3.

FIG. 1 shows a trolley 1 for moving picking personnel 2, 3 for the manual harvesting of mushrooms along a shelving (see FIG. 2) for growing those mushrooms, which trolley 1 has two longitudinal sides 4, 5 that extend between a front 6 and a rear 7 of the trolley 1, of which one longitudinal side 4 is designed to be moved close to the shelving during intended use parallel to the longitudinal direction L of the shelving, the trolley 1 comprising an accommodation 8 in or on which personnel 2, 3 can take place, formed by a standing surface 8, kept at a distance A with respect to a surface 9 formed by a floor surface 9 on which the trolley 1 can be moved, a guide 10, 11, 12 for guiding a harvesting belt 13 extending flatly along the shelving in a path through the trolley 1, wherein the path comprises a first part I in the longitudinal direction, wherein the harvesting belt 13 is located on one longitudinal side of the trolley 1 is located at a working height W defined with respect to the standing surface 8 for the staff 2, 3 to place harvested mushrooms on the belt, and a second part II wherein the harvest belt 13 is located at a position with respect to the standing surface 8 is at a lower height than the working height W to provide at least substantially unobstructed access to the shelving for harvesting mushrooms during use.

FIG. 2 shows the trolley 1 from FIG. 1, together with a shelving 14 in which there are beds 15, 16, 17 provided with compost 18, 19, 20 from which mushrooms are harvested. The working height W corresponds to that of the bed 15. The standing surface 8 can be lifted along masts 21, 22 to allow the beds 16 and 17 to be picked. It is visible that person 2 can position themselves closer to the shelving 14 because the trolley 1 comprises a part in which the longitudinal side 4 directed towards the shelving during use provides essentially unobstructed access to the shelving.

FIG. 3 shows a trolley 31 for moving picking personnel 32 for the manual harvesting of mushrooms along a shelving (see FIG. 4) for growing those mushrooms, which trolley 31 has two longitudinal sides 34, 35 that extend between a front side 36 and a rear 37 of the trolley 31, one longitudinal side 34 of which is designed to be moved close to the shelving during intended use parallel to the longitudinal direction L of the shelving, the trolley 31 comprising an accommodation 8 in which or on which personnel 32 can place. formed by a seat surface 38, kept at a distance AA with respect to a surface 39 formed by a floor surface 39 on which the trolley 31 can be moved, a guide 40, 41, 42 for guiding the trolley 31 in a path of a harvesting belt 43 extending flat along the shelving, wherein the track in the longitudinal direction comprises a first part I, wherein the harvesting belt 43 is located on one longitudinal side of the trolley 31 at a working height W defined with respect to the seat surface 38 for having the staff 32 place harvested mushrooms on the belt, and a second part II in which the harvesting belt 43 is located at a height lower than the working height W with respect to the standing surface 8 for providing at least an essentially unobstructed access to the mushroom harvesting shelving.

FIG. 4 shows the trolley 31 from FIG. 3, together with a shelving 44 in which there are beds 45, 46, 47 provided with compost 48, 49, 50 from which mushrooms are harvested. The working height W corresponds to that of the bed 45. The seat surface 38 can be lifted along masts 51, 52 to allow the beds 46 and 47 to be picked. It is visible that person 42 can position himself close to the shelving 44 because the trolley 31 comprises a part in which the longitudinal side 34 directed towards the shelving during use provides essentially unobstructed access to the shelving, while it can also reach the harvest belt 43.

FIG. 5 shows a shelving 101 for growing mushrooms, comprising several beds 102-106 placed one above the other for keeping compost and/or casing soil, a frame 107 coupled or connectable to the shelving, which has at least a horizontal directional component H along the shelving is movable; a harvesting belt conveyor, comprising a harvesting belt 108 extending at least partly parallel to the beds, supported by a number of guides 109-112, over which the harvesting belt is movable, with at least one of the guides being connected to the frame and along it to at least one vertical direction component V is movable, for guiding the harvesting belt 108 at least locally at an adjustable height along the shelving 101. In the configuration shown, the harvesting belt 108 is set to a height that is suitable for harvesting mushrooms from bed 103.

The frame 107 is designed, in particular by means of a coupling device, to be coupled to a trolley (see FIGS. 103 and 104) for moving the trolley and the frame 107 together with a horizontal directional component along the shelving.

When the frame 107 is moved in horizontal direction H relative to the shelving 1, all conductors 109-112 move along in their mutual relationship. The band part A increases in length and the other band parts B-E only change position. Part D is used to place picked mushrooms and remove them in direction H.

FIG. 6 shows the shelving 101 from FIG. 5, where the guides 109-112 have been adjusted in height. The guides 109 and 110 have moved apart and the track section B has increased in length. The track section B is now aligned such that the harvesting belt 108 is set to a height suitable for harvesting mushrooms from bed 106.

FIG. 7 again shows shelving 1 with frame 107, in a condition coupled to trolley 113 for horizontal and vertical movement, wherein the harvesting belt 108 is set to a height that is suitable for harvesting mushrooms from bed 103. The guides 109-112 are arranged, in particular by means of a coupling device, for coupling with accommodation that can be moved with a vertical directional component, in particular a carrying platform 114 for mushroom pickers of a trolley, for moving the carrying platform along the shelving 101 together with a vertical directional component V 114 and conductors 109-112.

FIG. 8 shows the assembly of the shelving 101 with the frame 107 and the trolley 113 from FIG. 7, in a position in which the accommodation 114 for the mushroom pickers has been moved in the vertical direction. The guides 109-112 for the harvesting belt are arranged for guiding the harvesting belt 108 in a path along the trolley, wherein the path comprises a first part I in a longitudinal direction, wherein the harvesting belt is located on one longitudinal side of the trolley at a a working height defined in relation to the standing surface or the sitting surface for staff to place harvested mushrooms on the belt, and a second part II in which the harvesting belt is at a position in relation to the standing surface or the sitting surface. at a height lower than the working height to provide at least substantially unobstructed access to the shelving for harvesting mushrooms during use. In the configuration shown, the second height corresponds to the supply height of part A of the harvesting belt.

### Clauses

1. Lorry for moving picking personnel for the manual harvesting of mushrooms along a shelving for growing those mushrooms, which lorry has two longitudinal sides that extend between a front and a rear of the lorry, one longitudinal side of which is designed to to be moved parallel to the longitudinal direction of the shelving during intended use, the trolley comprising:
an accommodation in which or on which personnel can sit, such as a standing surface or a sitting surface, kept at a distance from a surface, such as a floor surface on which the lorry can be moved;
a guide for guiding a harvesting belt extending flatly along the shelving in a path through the lorry, wherein the path comprises a first section in the longitudinal direction, wherein the harvesting belt is located on one longitudinal side of the lorry at a position relative to the standing surface or the sitting surface is at a defined working height for staff to place harvested mushrooms on the belt, and a second part in which the harvest belt is at a height lower than that of the standing surface or the sitting surface. the working height is to provide at least substantially unobstructed access to the shelving for harvesting mushrooms during use.

2. Lorry according to clause 1, wherein the working height is between 60 and 150 cm and in particular between 90 and 120 cm above a standing surface, or between 0 and 60, and in particular between 20 and 40 cm above a sitting surface.

3. Lorry according to clause 1 or 2, wherein the track is at a lower height than the working height on at least part of the side of the longitudinal side located at the front and on at least part of the side located at the rear from the longitudinal side at the working height.

4. Lorry according to clause 1 or 2, wherein the guide guides the belt along a track that is substantially S-shaped in side view, wherein the track comprises an input location at a front on a low side of the S, and at the rear at the high side of the S includes an output location.

5. Lorry according to clause 4, wherein the high side corresponds at least substantially to the working height.

6. Lorry according to clause 4, wherein the input location is at a height between 0 and 50 cm from the surface.

7. Lorry according to one of the preceding clauses, wherein the seat surface and/or the standing surface and the first part of the track are movable in height relative to the surface, in order to adjust the working height with a shelving available growing bed for mushrooms.

8. Lorry according to clause 7, wherein the output location moves in height with the sitting surface and/or the standing surface.

9. Lorry according to any of the preceding clauses, wherein the guide comprises a number of roller guides connected to the trolley, through which the belt can be looped during use.

10. Lorry according to any one of the preceding clauses, wherein the guide is freely accessible on a longitudinal side facing the shelving during use, for placing the belt on the guide or removing the belt from the guide.

11. Lorry according to one of the preceding clauses, which can be moved autonomously and can therefore be moved independently of the shelving.

12. Assembly of:
a shelving for growing mushrooms, in which there are one or more growing beds for growing mushrooms and in which a harvest belt extends lengthwise along the shelving; and
a lorry according to one of the preceding claims.

1. A mushroom growing shelving, comprising:
a plurality of beds placed one above the other for keeping compost and/or casing soil;
A frame coupled or connectable to the shelving, which can be moved along the shelving with at least a horizontal directional component;
A harvest belt conveyor, comprising:
A harvest belt extending at least partially parallel to the beds, supported by:
A number of guides over which the harvesting belt can move;
whereby:
at least one of the guides is connected to the frame and can be moved along it with at least a vertical directional component, for guiding the harvesting belt at least locally at an adjustable height along the shelving.

2. The shelving according to claim 1, the frame of which is configured, in particular by means of a coupling device, to be coupled to a trolley for moving the trolley and the frame together with a horizontal directional component along the shelving.

3. The shelving according to claim 1, wherein the at least one guide that can be moved along the frame with at least a vertical direction component is configured, in particular by means of a coupling device, for coupling with a carrying platform for mushroom pickers of a trolley, for moving the carrying platform and the guide along the shelving together with a vertical directional component.

4. The shelving according to claim 1, wherein several guides are connected to the frame, such that a harvesting belt arranged on the guides extends over a vertically movable, substantially horizontally extending path along the harvesting belt.

5. A trolley comprising a movable, in particular autonomously mobile, chassis, configured to be coupled to a frame mounted on a shelving and to move the frame along the shelving during movement of the trolley, the trolley comprising two longitudinal sides that extend extending between a front side and a rear side of the trolley, one longitudinal side of which is designed to be moved close to the shelving parallel to the longitudinal direction of the shelving during intended use, the trolley comprising:
an accommodation in which or on which personnel can sit, such as a standing surface or a sitting surface, kept at a distance from a surface, such as a floor surface on which the trolley can be moved; and/or
an automated picking or harvesting device, such as a robot.

6. The trolley according to claim 5, wherein the accommodation is movable in height relative to the chassis and wherein the trolley and in particular the platform thereof is designed for moving the at least one guide in vertical direction, which is connected with at least a vertical directional component is movable along the frame, for guiding the harvesting belt at least locally at an adjustable height along the shelving.

7. An assembly of the shelving according to claim 1 and the trolley according to claim 5.

8. The assembly according to claim 7, wherein the frame is provided with several guides for the harvesting belt, for guiding the harvesting belt in a path along the trolley, wherein the path comprises a first part in a longitudinal direction, wherein the harvesting belt, at a first longitudinal side of the trolley, is at a working height defined in relation to the standing surface or the seat surface for staff to place harvested mushrooms on the belt, and a second part in which the harvest belt is at a position in relation to the standing surface or the seat surface, at a lower height than the working height to provide at least substantially unobstructed access to the shelving for harvesting mushrooms during use.

9. The assembly according to claim 8, wherein the working height is between 60 and 150 cm and in particular between 90 and 120 cm above a standing surface, or between 0 and 60, and in particular between 20 and is 40 cm above a seat surface.

10. The assembly according to claim 7, wherein a track is located at a lower height than the working height on at least a part of the longitudinal side located at the front and on at least a part of the longitudinal side at the rear side of the longitudinal side is at the working height.

11. The assembly according to claim 10, wherein the guide guides the belt according to a track that is substantially S-shaped in a side view, wherein the track comprises an input location at a front on a low side of the S, and at the rear on a high side of the S includes an output location.

12. The assembly according to claim 11, wherein the high side corresponds at least substantially to the working height.

13. The assembly according to claim 11, wherein the input location is at a height between 0 and 50 cm from the surface.

14. The assembly according to claim 7, wherein the sitting surface and/or the standing surface and the first part of the track can be moved in height relative to the surface, in order to adjust the working height with a cultivation bed for mushrooms present in the shelving.

15. The assembly according to claim 11, wherein the output location moves in height with the sitting surface and/or the standing surface.
